(19) United States
(12) Patent Application Publication
(10) Pub. No.: US 2014/0069009 A1
(43) Pub. Date: Mar. 13, 2014

(54) HYDROPONIC CIRCULATION LIQUID SUPPLY DEVICE

(71) Applicant: Ming-Tsun Lin, Zhubei City (TW)

(72) Inventor: Ming-Tsun Lin, Zhubei City (TW)

(21) Appl. No.: 13/609,667

(22) Filed: Sep. 11, 2012

(51) Int. Cl. A01G 31/02

(52) U.S. Cl. 47/62 C

(57) ABSTRACT

A hydroponic circulation liquid supply device is composed of a tray body, a liquid supply platform and a motor. The tray body has a containing space for disposing a liquid supply platform. The liquid supply platform is formed with a liquid supply region and a guide passage region communicating with each other by disposing a first rib. The liquid supply region is disposed with a plurality of second ribs to form a liquid supply passage. A water collection region is further disposed in the tray body. The liquid supply region and the guide passage region have a section difference plane. The motor is engaged with the water collection region and the liquid supply region respectively to form a flowing circulation loop of transporting culture liquid, and the flowing speed of culture liquid can be slowed down.

### BACKGROUND OF THE INVENTION

1. Field of the Invention

The present invention generally relates to a hydroponic device, in particular to a hydroponic circulation liquid supply device that does not wash water content and nutrient supplied by culturing away to repeatedly utilize the water content and nutrient and circularly supplying culture solution.

2. Description of the Related Art

A traditional large-sized planting field normally utilizes opening-type planar farmlands and needs great areas and is easily affected by weather to cause unstable production. Further, this kind of field may be polluted by species. Moreover, traditional plowing manner is not suitable for modern people who live in the city. Therefore, a manner of hydroponic planting is recently popular. The manner of hydroponic planting can allow people who are restricted by living environment without additional space to utilize a corner at home to plant vegetables. It does not only prevent vegetables having pesticide residual sale in the market from being eaten but also reduces many entertainment expenses while enjoying fun of planting plants.

Crop cultivation mainly utilizes related facilities to control energy resources of growing plants, including illumination, water, and air, to obtain stable and high quality yields, thereby enhancing the output value of the yields. Although the space utilization of hydroponic cultivation is simpler than traditional tillage, the conventional hydroponic cultivation must allow hydroponic plant roots to immerse in the culture solution as the principle.

Moreover, illumination and water are very important elements of planting and growing plants. The growth of plants almost relies on photosynthesis. Therefore, in many conditions of influencing plants' growth, sufficient illumination condition may influence the growth quality of plants. Further, daily water supply and irrigation causes time consuming and requires much work. Controlling plant environment based upon features of plants' life habit and growth rules becomes an important link for crop cultivation technique.

### SUMMARY OF THE INVENTION

Therefore, it is a primary objective of the present invention to provide a hydroponic circulation liquid supply device that can repeatedly utilize the water content and nutrient supplied by planting without washing away and circularly supplying culture liquid.

To achieve the foregoing objective, the present invention provides a hydroponic circulation liquid supply device comprising a tray body, a liquid supply platform and a motor, wherein the tray body has a containing space for disposing a liquid supply platform. The periphery of the liquid supply platform is disposed with a baffle. The liquid supply platform is disposed with a first rib and formed with a liquid supply region and a guide passage region. Further, the liquid supply region is disposed with a plurality of second ribs interlaced to form a liquid supply passage. Moreover, the tray body is disposed with a water collection region. The liquid supply region and the guide passage region have a section difference plane, and the motor is engaged with the water collection region and the liquid supply region respectively to pump culture liquid in the water collection region to the liquid supply region.

While in use, the tray body is further disposed with a colonization board and a LED lamp board. The colonization board is provided for positioning and planting plant seeding, and the colonization board is fixedly disposed to the corresponding liquid supply passage to provide the culture liquid required for growing plant seeding through the supply circulation system, and the culture liquid is not washed away and can be repeatedly utilized. Secondary, the LED lamp board can regulate and control temperature and light source to properly provide illumination and stable environment, thereby speeding up the growth of plant seeding.

The features of the invention comprises:

1. The culture liquid in the tray body can be formed with a flowing circulation loop through the water collection region, the liquid supply region and the guide passage region, thereby adequately utilizing the culture liquid without washing away.

2. The flowing speed of the culture liquid flowing in the liquid supply passage can be slowed down through the interlaced second ribs.

3. The culture liquid slowly flowing in the liquid supply region can be naturally guided to the lower guide passage region through the section difference plane and the gravity.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a stereo structure diagram of the present invention;

FIG. 2 is a structural decomposition drawing in accordance with a first embodiment of the present invention;

FIG. 3 is a schematic view of a circulation loop structure in accordance with a first embodiment of the present invention;

FIG. 4 is a structural diagram in accordance with a second embodiment of the present invention;

FIG. 5 is a structural diagram in accordance with a third embodiment of the present invention;

FIG. 6 is a structural diagram in accordance with a fourth embodiment of the present invention; and

FIG. 7 is another structural diagram in accordance with the present invention.

### DETAILED DESCRIPTION OF THE PREFERRED EMBODIMENTS

The technical content of the present invention will become apparent by the detailed description of the following embodiments and the illustration of related drawings as follows.

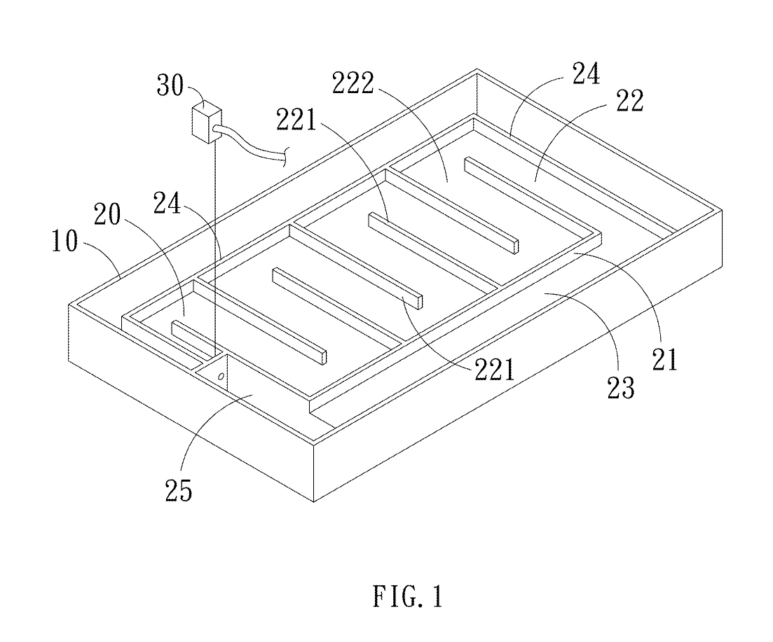

With reference to FIG. 1 for a hydroponic circulation liquid supply device of an invention is composed of a tray body 10, a liquid supply platform 20 and a motor 30. The tray 10 has a containing space. The liquid supply platform 20 is disposed in the tray body 10. The liquid supply platform 20 is to form a liquid supply region 22 and a communicate a guide passage region 23 communicating with each other through a first rib 21, and the liquid supply region 22 is disposed with a plurality of second ribs 221 to form a liquid supply passage 222. A periphery of the liquid supply platform 20 is disposed with a baffle 24. The tray body 10 is disposed with a water collection region 25 relative to another side of the liquid supply platform 20.

The motor 30 is disposed to the tray body 10. The motor 30 is respectively engaged with the water collection region 25 and the liquid supply region 22.

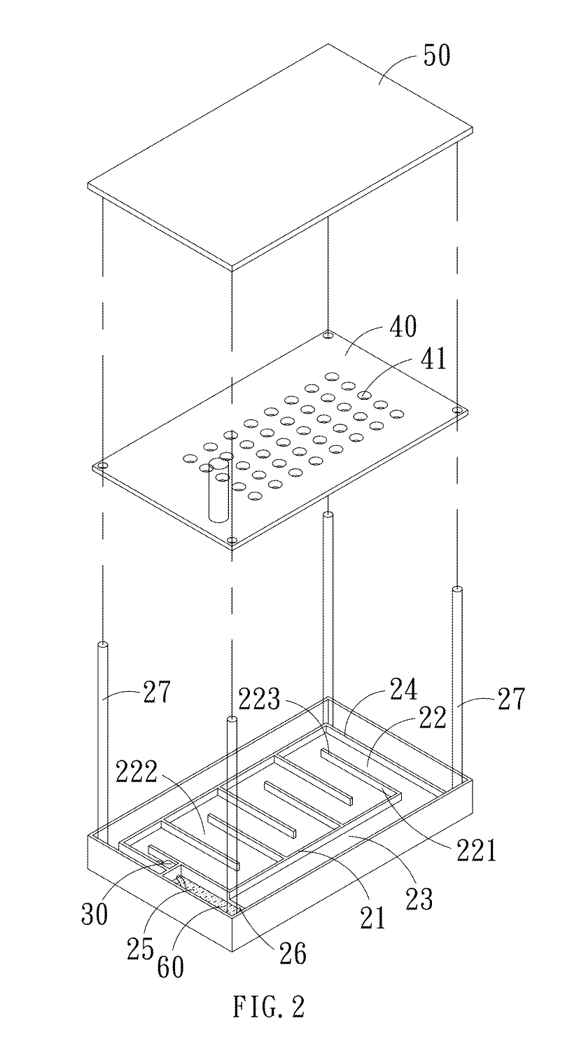

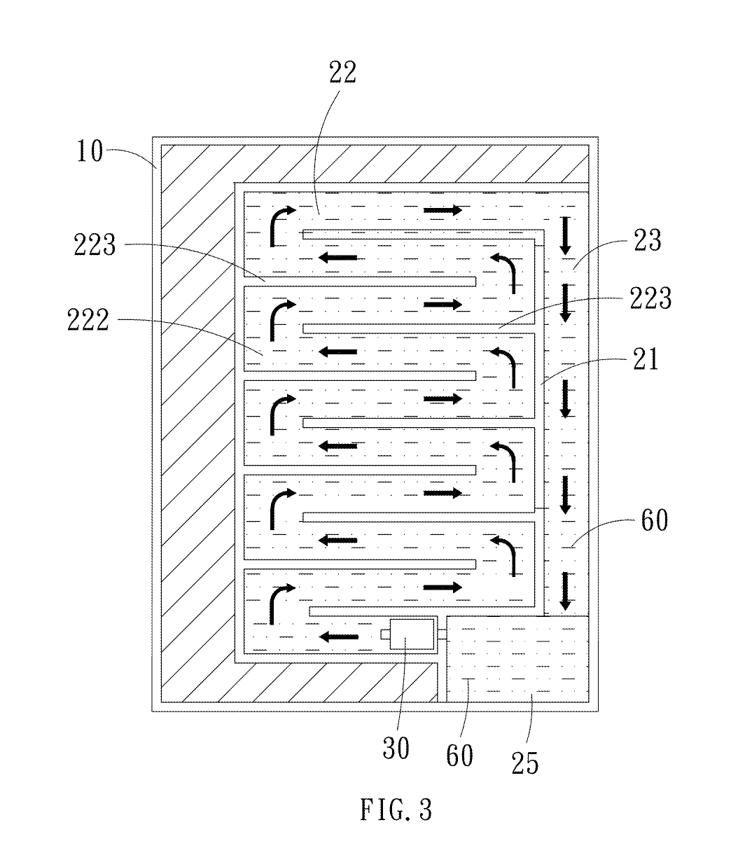

Accordingly, a first embodiment of the invention is shown in FIG. 2 and FIG. 3. The liquid supply region is the plane. The water collection region 25 is formed in the tray body 10 through the baffle 24 and the liquid supply platform 20. The tray body 10 is disposed with a colonization board 40 and a LED lamp board 50. The tray body 10 is disposed with a stand 27 to fasten the colonization board 40 and the LED lamp board 50. The colonization board 40 is disposed with a plurality of through holes 41 to position and culture plant seeding. The plurality of through holes 41 is fixedly disposed and corresponds to the liquid supply passage 222. The plurality of second ribs 221 is straight ribs 223 and interlaced in parallel to form the liquid supply passage 222. While in use, the water collection region is disposed with culture liquid and lower than the first section difference plane 26. The motor 30 is activated to pump the culture liquid 60 inside the water collection region 25 to the liquid supply region 22. The culture liquid 60 flows through the liquid passage 222 formed by the straight ribs 223 interlaced in parallel. The straight ribs 223 is facilitated to slow down the speed of the culture liquid 60 such that the culture liquid 60 has activity to provide plant seeding adequately absorbing nutrient. Secondary, the culture liquid 60 in the liquid supply passage 222 flows toward the guide passage region 23. The culture liquid 60 is guided into the water collection region 25 from the guide passage region 23. The culture liquid 60 naturally flows through the water collection region 25 from the guide passage region 23 by mainly utilizing gravity and the first section difference plane 26 so that the culture liquid 60 in the tray body 10 forms a flowing circulation loop at the liquid supply region 22, the guide passage region 23 and the water collection region 25, and the culture liquid is adequately utilized without washing away to provide illumination and stable environment, thereby speeding up the growth beneficent of plant seeding.

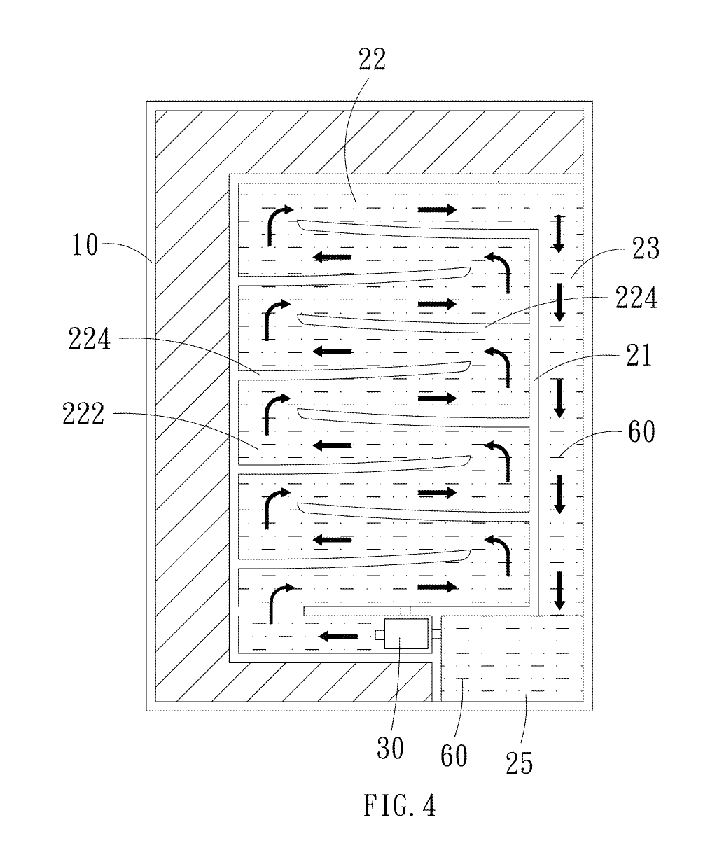

A second embodiment of the invention is shown as FIG. 4, the plurality of second ribs 221 is arc ribs 224 and interlaced in parallel to form the liquid supply passage 222. While in use, the motor 30 is activated to pump the culture liquid 60 in the water collection region 25 to the liquid supply region 22. The culture liquid 60 flows through the liquid supply passage 222 formed by interlacing the arc ribs 224. The speed of the culture liquid 60 can be slowed down by the arc ribs 224 to allow the culture liquid 60 in the slow flowing state having activity to provide plant seeding adequately absorbing nutrient.

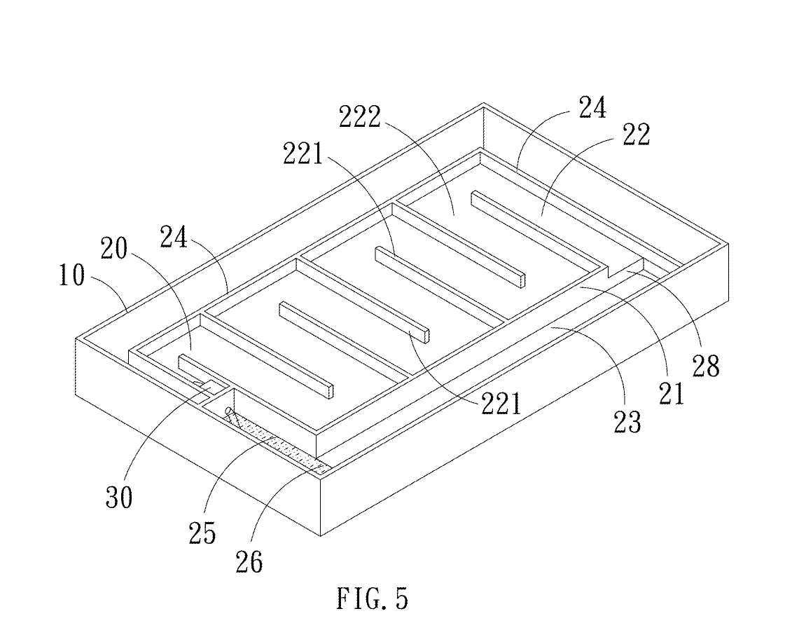

A third embodiment of the invention is shown in FIG. 5, the liquid supply region is the plane. The communication region between the liquid supply region 22 and a guide passage region 23 is disposed with a second section difference plane 28. When the culture liquid 60 flows through the guide passage region 23 from the liquid supply passage 222, the flowing of the culture liquid 60 has dragging flow through the second section difference plane 28 to facilitate the culture liquid 60 flowing through the guide passage region 23 from the liquid supply region 22, and the culture liquid 60 is guided into the water collection region 25 from the guide passage region 23. The culture liquid 60 naturally flows through the water collection region 25 from the guide passage region 23 by utilizing gravity and the first section difference plane 26 such that the culture liquid 60 in the tray body 10 at the liquid supply region 22, the guide passage region 23 and the water collection region 25 forms a flowing circulation loop to adequately utilize the culture liquid 60 without flowing away, thereby increasing growth benefit of culturing hydroponic plants.

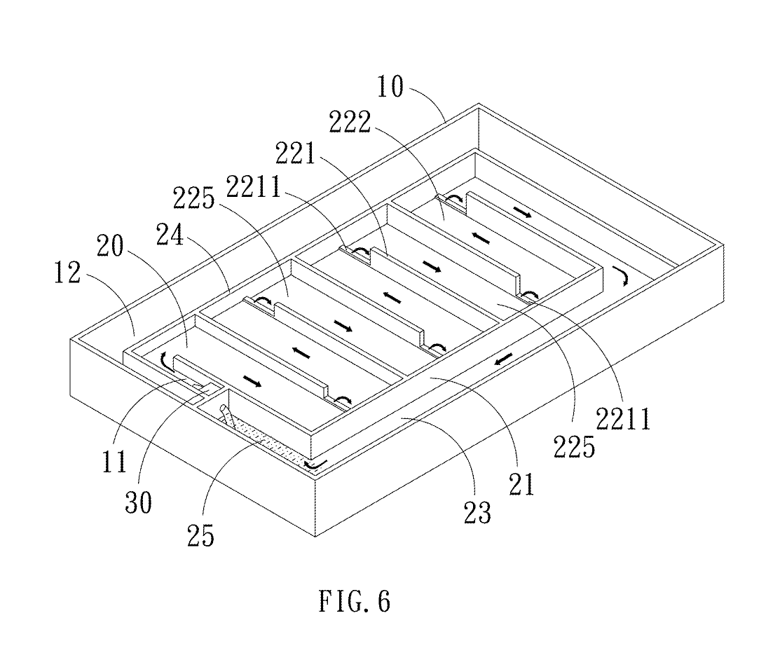

A fourth embodiment of the invention is shown in FIG. 6. The liquid supply region 22 has stair layers 225. The plurality of stair layers 225 is relatively vertical the plurality of second ribs 221, and the plurality of second ribs 221 is disposed with overflow portions 2211 interlaced with each other to form a liquid supply passage 222. The overflow portions 2211 have a predetermined height. When the culture liquid 60 is in the liquid supply passage 222, the overflow portions 2211 can temporarily store the culture liquid 60 in the liquid supply passage 222. When the temporarily stored culture liquid 60 is higher than the overflow portions 2211, the culture liquid 60 overflows through next water passage. The flow rate generated from the section difference between the stair layers 225 imposes the culture liquid 60 in the liquid supply passage 222 flowing toward a direction of the overflow portions 2211. The flowing of the culture liquid 60 has dragging flow property to facilitate the culture liquid 60 flowing through the guide passage region 23 from the liquid supply region 22, and the culture liquid 60 then is guided into the water collection region 25 from the guide passage region 23 to allow the culture liquid 60 in the tray body 10 to form a flowing circulation loop at the liquid supply region 22, the guide passage region 23 and the water collection region 25 such that the culture liquid 60 is adequately utilized without flowing away, thereby increasing the growth benefit of culturing hydroponic plants.

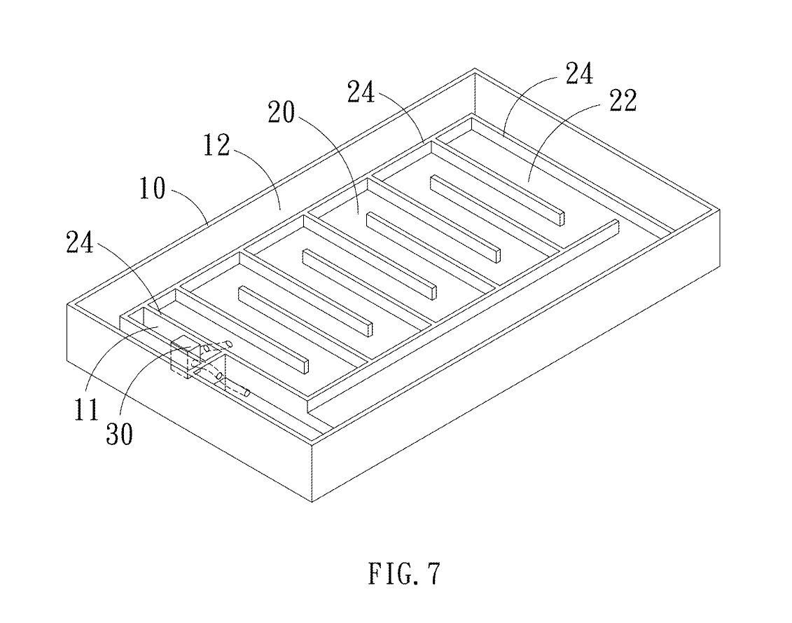

In addition, as shown in FIG. 6 and FIG. 7, the tray body 10 is formed with an installation portion 11 through the baffle 24 and the liquid supply platform 20 to dispose the motor 30 preventing humidity. Alternatively, the tray body 10 can be disposed with a fastening holder (not shown in the figure) for raising the motor 30 to prevent humidity. Alternatively, the motor 30 can be a submerged motor installed in the water collection region 25. Furthermore, as shown in FIG. 6, the containing space of the tray body 10 is formed with an article placing region 12 relative to another side of the liquid supply platform 20 through the baffle 24 so that articles can be conveniently placed to prevent humidity. Moreover, the motor installation portion 11 or the fastening holder has the height as well as the water collection region 25. The culture liquid 60 is outputted by the output force of the motor to generate flow rate to facilitate the culture liquid 60 flowing forward in the liquid supply region 22.

The motor placing region has the height as well as the water collection region. With the output force of the motor, the culture liquid 60 generating the flow rate flows forward in the liquid supply region 22.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A hydroponic circulation liquid supply device comprising:
a tray body having a containing space;
a liquid supply platform disposed in the tray body, the liquid supply platform forming a liquid supply region and a guide passage region communicating with each other through a first rib, the liquid supply region disposed with a plurality of ribs to form a liquid supply passage, a periphery of the liquid supply platform disposed with a baffle, the tray body disposed with a water collection region relative to another side of the liquid supply platform;
a motor disposed to the liquid supply platform, the motor engaged with the water collection region and the liquid supply region respectively.

2. The hydroponic circulation liquid supply device of claim 1, wherein the liquid supply region is a plane, and the plurality of second ribs interlaced to form a liquid supply passage, the guide passage region and the water collection region having a first section difference plane.

3. The hydroponic circulation liquid supply device of claim 2, wherein the liquid supply region and the guide passage region have a second section difference plane.

4. The hydroponic circulation liquid supply device of claim 2, wherein the plurality of second ribs is straight ribs and interlaced in parallel to form the liquid supply passage.

5. The hydroponic circulation liquid supply device of claim 2, wherein the plurality of second ribs is arc ribs and interlaced with each other to form the liquid supply passage.

6. The hydroponic circulation liquid supply device of claim 2, wherein the tray body is disposed with a colonization board and fixedly disposed with a LED lamp board.

7. The hydroponic circulation liquid supply device of claim 2, wherein the tray body is disposed with a colonization board and fixedly disposed with a LED lamp board, and the tray body is disposed with a plurality of stands, and the colonization board is passed by the plurality of stands and corresponds to the tray body, and the LED lamp board is fastened by the plurality of stands and disposed on the colonization board, and the colonization board is disposed with a plurality of through holes provided for fastening vegetable seeding, and the plurality of through holes corresponds to the liquid supply passage.

8. The hydroponic circulation liquid supply device of claim 2, wherein the containing space of the tray body is disposed with an article placing region relative to another side of the liquid supply platform.

9. The hydroponic circulation liquid supply device of claim 2, wherein the tray body is disposed with an installation portion to dispose the motor.

10. The hydroponic circulation liquid supply device of claim 2, wherein the tray body is disposed with a fastening holder for raising the motor.

11. The hydroponic circulation liquid supply device of claim 2, wherein the motor is a submerged motor.

12. The hydroponic circulation liquid supply device of claim 2, wherein the water collection region is filled with culture liquid.

13. The hydroponic circulation liquid supply device of claim 1, wherein the liquid supply region has stair layers, and the plurality of stair layers is relatively vertical the plurality of second ribs, and the plurality of second ribs is disposed with overflow portions interlaced with each other to form a liquid supply passage, and the overflow portions have a predetermined height.

14. The hydroponic circulation liquid supply device of claim 13, wherein the tray body is disposed with a colonization board and fixedly disposed with a LED lamp board.

15. The hydroponic circulation liquid supply device of claim 13, wherein the tray body is disposed with a colonization board and fixedly disposed with a LED lamp board, and the tray body is disposed with a plurality of stands, and the colonization board is passed by the plurality of stands and corresponds to the tray body, and the LED lamp board is fastened by the plurality of stands and disposed on the colonization board, and the colonization board is disposed with a plurality of through holes provided for fastening vegetable seeding, and the plurality of through holes corresponds to the liquid supply passage.

16. The hydroponic circulation liquid supply device of claim 13, wherein the containing space of the tray body is disposed with an article placing region relative to another side of the liquid supply platform.

17. The hydroponic circulation liquid supply device of claim 13, wherein the tray body is disposed with an installation portion to dispose the motor.

18. The hydroponic circulation liquid supply device of claim 13, wherein the tray body is disposed with a fastening holder to raise the motor.

19. The hydroponic circulation liquid supply device of claim 13, wherein the motor is a submerged motor.

20. The hydroponic circulation liquid supply device of claim 13, wherein the water collection region is filled with culture liquid.
